(19) United States
(12) Patent Application Publication
(10) Pub. No.: US 2025/0372894 A1
(43) Pub. Date: Dec. 4, 2025

(54) SEALING WASHER FOR AN ELECTRICAL CONNECTION, ASSEMBLY FOR PROTECTING AN ELECTRICAL CONNECTION, AND AIRCRAFT

(71) Applicant: Airbus Operations SAS, TOULOUSE (FR)

(72) Inventor: Benjamin BOISNIER, TOULOUSE (FR)

(21) Appl. No.: 19/215,571

(22) Filed: May 22, 2025

(30) Foreign Application Priority Data
May 29, 2024 (FR) FR2405540

(51) Int. Cl. H01R 4/34; H01R 4/30; H01R 11/12

(52) U.S. Cl. CPC H01R 4/34; H01R 4/304; H01R 4/305; H01R 11/12; H01R 2201/26

(57) ABSTRACT

An anti-corrosion sealing washer made of a watertight material, such as a silicone, and having two peripheral tabs configured for gripping the sealing washer, and at least two locating pins. Also a protective assembly with such a sealing washer and a connecting second washer having a groove on its edge face and a protective cap having an inner annular relief with a complementary shape to the groove of the connecting washer.

### CROSS-REFERENCES TO RELATED APPLICATIONS

This application claims the benefit of French Patent Application Number FR2405540 filed on May 29, 2024, the entire disclosure of which is incorporated herein by way of reference.

### FIELD OF THE INVENTION

The present invention relates to a sealing washer and to an assembly for protecting an electrical connection comprising at least one such sealing washer, a connecting washer and a cap. The invention also relates to an aircraft comprising such a sealing washer or such a protective assembly.

### BACKGROUND OF THE INVENTION

An aircraft has numerous mechanical and electrical connections that have to be protected against corrosion. Electrical connections are sometimes established using a cable, at least one end of which is provided with a connecting washer (eyelet terminal) made of an electrically conductive material through which a fastening screw is inserted. The fastening screw makes it possible to fasten the connecting washer to an electrically conductive connecting element, thus creating an electrical connection point. For example, this may be a point of connection to ground or a point of connection to an equipotential, such as a busbar. In order to prevent the connection point thus formed from corroding, a protective mastic is applied to the screw head, the connecting washer of the cable and its immediate surroundings, in order to protect all of these elements against moisture. Such application of mastic is restrictive in so far as the quality of the protection obtained depends on the quality of the local application of mastic and additionally requires the mastic and a tool for applying the mastic to be handled, in addition to handling the connecting elements themselves. In addition, this handling slows down operations and is impeded when the operator has only restricted access and low visibility to do so. Another disadvantage is that the mastic has to be scraped off during a disassembly operation, which is long and onerous and generates mastic chips or dust. Furthermore, such a stripping operation often damages the component in question, requiring it to be replaced.

The situation can be improved.

### SUMMARY OF THE INVENTION

One object of the present invention is to make it easier to protect electrical connection points against corrosion, in particular in aircraft systems.

To this end, a sealing washer made of a watertight material and comprising two peripheral tabs configured for gripping the sealing washer is proposed, said sealing washer also having at least two locating pins.

Advantageously, this makes it possible to correctly and quickly position the sealing washer against the end eyelet of an electrical connection cable, even in locations that are not readily accessible.

According to one embodiment, the locating pins are respectively arranged on lugs of the sealing washer.

Advantageously and according to one embodiment, the watertight manufacturing material of the sealing washer is a silicone.

Another object of the invention is a protective assembly comprising:
a sealing first washer, as described above,
a second washer, referred to as connecting washer, preferably made of an electrically conductive material, and
a protective cap,
said assembly being such that the second washer has a groove on its edge face, and the inside of the cap having an inner annular relief with a complementary or substantially complementary shape to the groove of the second washer.

Advantageously, the cap comprises a slot, an opening or a tab.

The invention also relates to an aircraft comprising at least one sealing washer as described above or a connecting assembly as described above.

### BRIEF DESCRIPTION OF THE DRAWINGS

FIG. 1 is a schematic and perspective illustration of an anti-corrosion sealing washer according to one embodiment, positioned facing an end eyelet terminal of an electrical connection cable or an end part of a busbar;

FIG. 2 is a perspective illustration of the sealing washer illustrated in FIG. 1 positioned against the eyelet terminal, which has also already been shown in FIG. 1;

FIG. 3 is a perspective illustration of a washer that is referred to as connecting washer, has a groove on its edge face and is configured, according to one embodiment, to be pressed against the eyelet terminal already shown in FIG. 1 and FIG. 2 and to be held tightly against the eyelet terminal by virtue of a screw or a bolt;

FIG. 4 is a perspective illustration of the connecting washer already shown in FIG. 3, when it is positioned against the eyelet terminal shown in FIG. 1 and FIG. 2;

FIG. 5 is a perspective illustration of a screw head cap comprising an inner annular relief with a complementary shape to the groove of the connecting washer shown in FIG. 3 and FIG. 4 and configured to fit onto the connecting washer;

FIG. 6a is a perspective illustration of an assembly, according to one embodiment, of an electrical connection point by means of a screw, and of the connecting elements shown in figures FIG. 1 to FIG. 5;

FIG. 6b is a perspective illustration of a variant assembly of the connection point shown in FIG. 6a;

FIG. 7a is a perspective illustration of the connection point shown in FIG. 6a, after assembly, according to one embodiment;

FIG. 7b is a perspective illustration of a variant of the connection point shown in FIG. 7a;

FIG. 8 is a perspective illustration of another variant of the connection point shown in FIG. 7a and FIG. 7b; and

FIG. 9 is a side view of an aircraft comprising a sealing washer or an electrical connection point according to one embodiment.

### DETAILED DESCRIPTION OF THE PREFERRED EMBODIMENTS

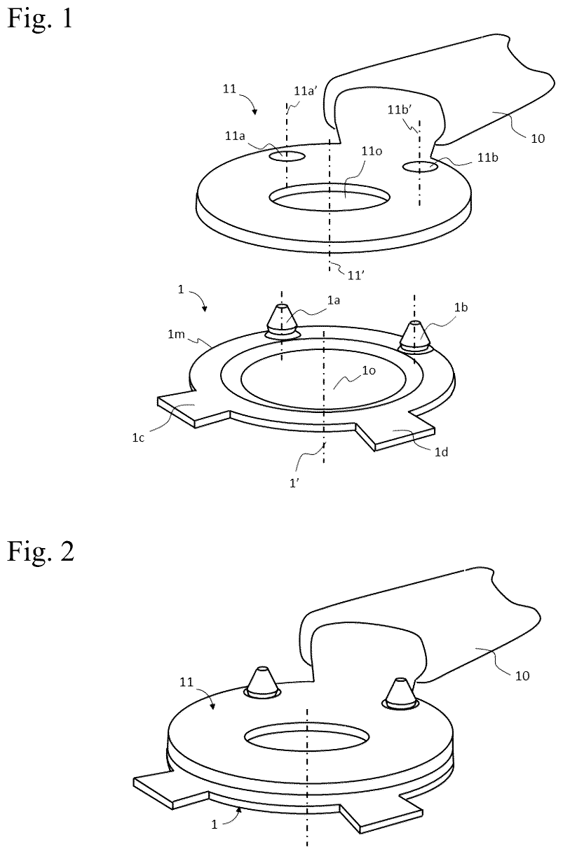

FIG. 1 schematically shows a sealing washer 1 positioned facing an eyelet terminal 11, which is an end part of an electrical connection cable 10. The sealing washer 1 is an anti-corrosion washer in so far as it is made of a material that is watertight and more generally liquid-tight, thereby preventing any corrosion of the sealing washer 1. According to one embodiment, the sealing washer 1 is manufactured from silicone. Ingeniously and advantageously, the sealing washer 1 comprises two gripping tabs 1c and 1d, also referred to as “lugs”, projecting from the periphery of its body 1m, and two locating pins 1a and 1b on a flat surface of the body of the sealing washer intended to come into contact with the eyelet terminal 11. The locating pins 1a and 1b enable the sealing washer 1 to be positioned quickly against the eyelet terminal 11 in a predetermined position. To this end, and according to the example described, the eyelet terminal 11 has two through-openings 11a and 11b configured to receive the locating pins 1a and 1b. Advantageously, the through-opening 11a is arranged around a central axis 11a′ and the through-opening 11b is arranged around a central axis 11b′. Advantageously, the spacing (or the distance) between the axes 11a′ and 11b′ is equal to the distance separating the central axes of the locating pins 1a and 1b, such that there is just one predetermined precise position, which makes it possible to position the leak-tight washer against the eyelet of the eyelet terminal 11 or more specifically against the face of the eyelet of the eyelet terminal 11 that is on the opposite side to the face connected to the electrical connection cable 10.

Placing the sealing washer 1 against this face of the eyelet of the eyelet terminal 11 makes it possible to protect this face of the eyelet terminal 11 against corrosion when the latter is fastened and held against a third-party connecting element, so as to produce an electrical connection point. According to one embodiment, the gripping tabs 1c and 1d have a rectangular or square shape and are each dimensioned so as to enable them to be held between the thumb and index finger of an operator assembling electrical connection points. Ingeniously, the locating pins 1a and 1b project from a flat surface of the annular body 1m of the sealing washer 1, at the outer edge of the face of the sealing washer 1 that bears them, and each have a shape that allows them to be inserted into a cavity or a through-opening formed at the outer edge of the eyelet of the eyelet terminal 11 of the connection cable 10. According to a variant embodiment, the locating pins are not arranged at the outer edge of the face of the sealing washer 1 that bears them, but on peripheral lugs, of any shape, which are arranged in a similar manner to the gripping tabs 1c and 1d, but not in the same locations. Advantageously, the sealing washer 1 has a central through-opening 1o arranged around a central axis 1′ and the eyelet of the eyelet terminal 11 has a through-opening 11o arranged around a central axis 11′. The openings 1o and 11o allow a fastening and retaining screw or bolt to pass in order to create an electrical connection point.

According to one embodiment, the surface of the eyelet terminal 11 may have a flat shape around the through-opening 11o. According to a variant, the surface of the eyelet terminal 11 has a recessed or tapered surface around the through-opening 11o, which is configured to make it easier to position or house a screw head passing through the through-opening 11o.

FIG. 2 illustrates the sealing washer 1 positioned against the eyelet terminal 11 of the electrical connection cable 10. This example is non-limiting, and the cable can be replaced by a conductive element (a shaped metal sheet or a busbar, for example). It is possible to see the ends of the locating pins inserted into the through-openings of the eyelet of the eyelet terminal 11 and thus positionally locating it so as to quickly position the sealing washer 1 in a predetermined manner on the face of the eyelet terminal that is on the opposite side to the face connected to the electrical connection cable 10.

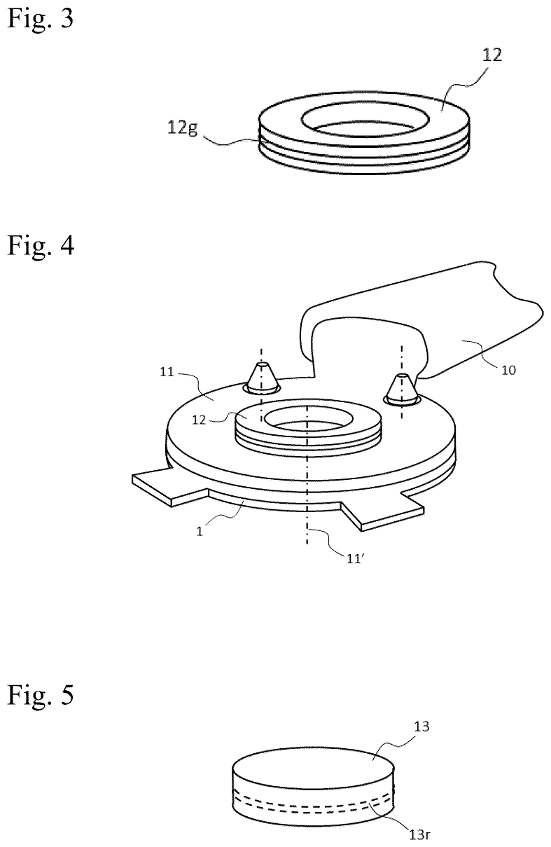

FIG. 3 illustrates a washer 12 referred to as connecting washer 12 having a groove 12g over the entire length of its edge face, i.e., on the edge of the connecting washer 12 separating its two faces. According to one embodiment, the connecting washer 12 is configured to be pressed against the eyelet terminal 11 and to be held tightly against the eyelet terminal 11 by virtue of a screw inserted into the aligned central openings of the sealing washer 1, of the eyelet of the eyelet terminal 11 and of the connecting washer 12. According to one embodiment, the overall diameter of the connecting washer 12 is smaller than the distance separating the central axis of the eyelet of the eyelet terminal 11 and the point on the locating pins closest to this axis.

FIG. 4 shows the connecting washer 12 positioned on the eyelet terminal 11 when the eyelet terminal 11 is positioned against the sealing washer 1.

FIG. 5 shows a cap 13 for protecting the screw head and connecting washer. According to one embodiment, the cap 13 comprises an inner annular relief 13r with a complementary or substantially (i.e., +/−10%) complementary shape to the groove 12g of the connecting washer 12. A substantially complementary shape to the groove 12g in this case designates a shape that is not necessarily strictly complementary to the shape of the groove 12g but is sufficiently complementary for the insertion of the inner annular relief 13r of the cap 13 into the groove to result in mechanical locking in position and liquid-tightness or moisture-tightness, which allows the cap 13 to be held in position on the connecting washer 12 covered by the cap 13. Thus, the cap 13 performs a function of leak-tight protection of the electrical connection point formed, as does the sealing washer 1. According to one embodiment, the precise position of the inner annular relief 13r inside the cap 13 is designed so that an assembly of the cap 13 on the connecting washer 12 is such that the edge of the cap 13 is entirely in contact with the surface of the eyelet of the eyelet terminal 11 after assembling the connection point in order to obtain moisture-tight assembly.

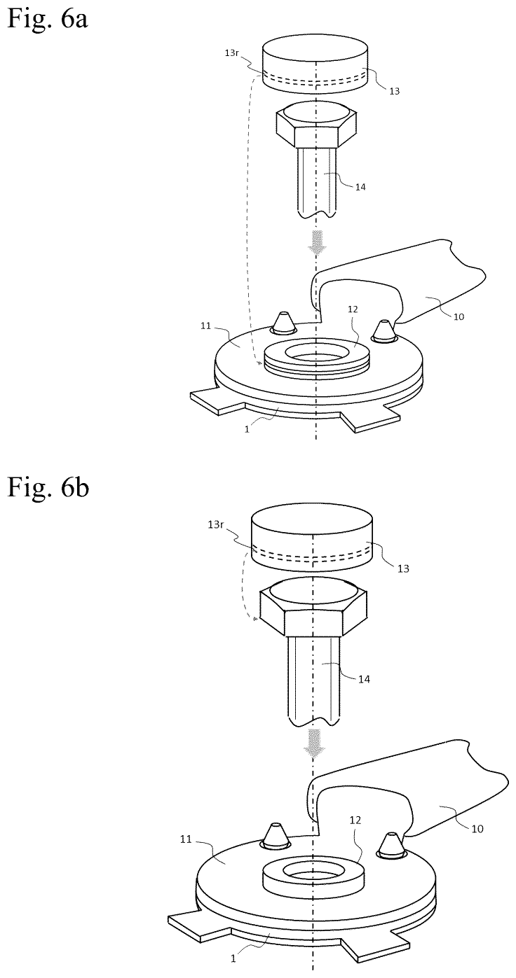

FIG. 6a shows an assembly in progress of an electrical connection point, according to one embodiment. The connection point is assembled using a screw 14 that is inserted into the aligned through-openings of the various connecting elements, namely the connecting washer 12, the eyelet terminal 11 and the sealing washer 1. A vertical arrow pointing downwards symbolizes the insertion of the screw 14 used for holding the connecting elements on a plane or a substrate of a connecting component, for example a ground plane or an equipotential of the busbar type. Another arrow, in dashed lines, illustrates in FIG. 6a the positioning of the inner annular relief 13r of the cap 13 in the groove 12g of the connecting washer 12, when the cap 13 is positioned so as to protect the head of the screw 14 and the connecting washer 12.

FIG. 6b shows a variant of the assembly in progress of the electrical connection point, which has already been described in relation to FIG. 6a, and according to which the inner annular relief 13r of the cap 13 is not intended to be housed in a groove of the connecting washer 12, but to be clipped directly under the edge of the head of the screw 14, this being represented by a dashed arrow in FIG. 6b. This advantageously makes it possible to use a washer without a groove. According to this variant, it is preferable for the screw 14 to have a screw head with a generally circular shape.

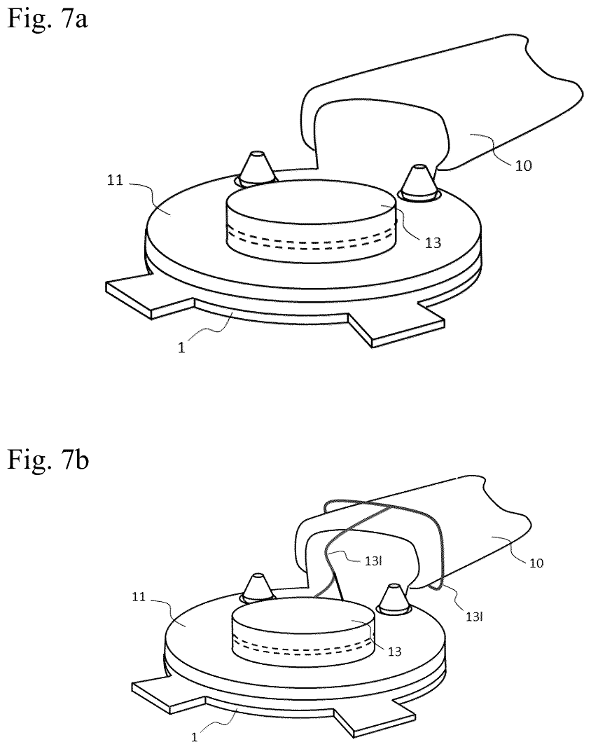

FIG. 7a shows a connection point formed after insertion of the screw 14, which is held by a nut (not visible in the figure) or screwed into an internal thread (not visible in the figure), and after the protective cap 13 has been installed.

FIG. 7b shows a variant of the connection point described in relation to FIG. 7a, according to which the cap 13 comprises a strap 131 (also referred to as a “tether”), an end part of which surrounds the cable 10, thereby advantageously making it possible to prevent it from falling during an assembly or disassembly operation. Advantageously, the risk of the presence of FOD (foreign object debris) is reduced when used in an aircraft.

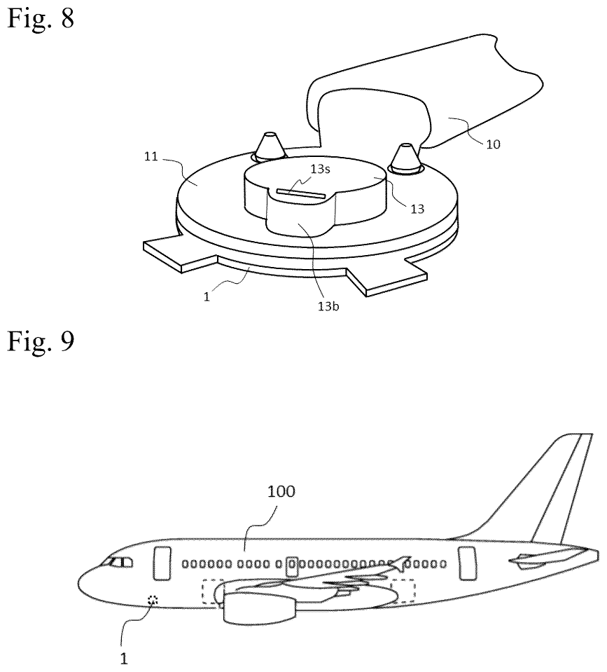

FIG. 8 shows a variant of the connection point already described in relation to FIG. 7a and FIG. 7b, according to which the cap 13 comprises a protruding or projecting surface 13b (also referred to as tab 13b) and also has a slot 13s defined along a plane parallel to the direction of insertion (installation) and withdrawal (removal) of the cap 13 on the screw head of the connection point. Advantageously, the cap 13 may have a cavity with a complementary or substantially complementary shape to the end of a shank of a tool or of a flat-head screwdriver, which advantageously makes it possible to remove the cap 13 by actuating the screwdriver or more broadly the tool thus designed using a lever movement. This makes it possible to achieve increased ease and speed during a disassembly operation.

According to a variant, a part of the cap 13 projects from the surface of the cap so as to form a tab or a notch so that the cap can be removed again simply by using a tool as a lever against the tab thus formed or in the notch thus formed.

According to one embodiment, the cap 13 simultaneously comprises the above-mentioned elements (slot, tab, etc. and a connecting strap for securing to a cable or to a metal sheet or a busbar).

According to one embodiment, the cap 13 may comprise at least one region of predefined weakness configured to tear or shear when a force is applied to the cap in order to remove the latter. This advantageously makes it possible to demonstrate a previous use for protecting a connection point.

FIG. 9 illustrates an aircraft 100 comprising at least the sealing washer 1 or a sealing washer similar to the washer 1 or at least one electrical connection point as described above, this advantageously making it possible to protect all or part of this electrical connection point without requiring the application of a leak-tight mastic. Such an assembly makes it possible to increase the speed of performing assembly and maintenance operations in relation to the type of electrical connection point described.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A sealing washer comprising:
two peripheral tabs configured for gripping said sealing washer,
wherein a surface of said sealing washer has at least two locating pins, and
wherein said sealing washer is made of a moisture-tight material.

2. The sealing washer according to claim 1, wherein said locating pins are respectively arranged on lugs of said sealing washer.

3. The sealing washer according to claim 1, wherein the moisture-tight material comprises a silicone material.

4. A protective assembly comprising:
the sealing washer according to claim 1;
a connecting second washer made of an electrically conductive material; and,
a protective cap,
said connecting second washer having a groove on an edge face, and
an inside of said protective cap having an inner annular relief with a complementary or substantially complementary shape to said groove of said connecting second washer.

5. The protective assembly according to claim 4, wherein said protective cap comprises a slot, or an opening, or a tab, or any combination thereof.

6. An aircraft comprising:
at least one sealing washer according to claim 1.
